(19) United States
(12) Patent Application Publication
(10) Pub. No.: US 2010/0185797 A1
(43) Pub. Date: Jul. 22, 2010

(54) KEYBOARD-MOUSE SWITCH AND SWITCHING METHOD THEREOF

(75) Inventors: Hsi-Jung Tsai, Hsinchu City (TW); Hao-Yang Chang, Miaoli County (TW); Shih-Hsuan Yen, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NUVOTON TECHNOLOGY CORPORATION, Hsinchu (TW)

(21) Appl. No.: 12/424,523

(22) Filed: Apr. 15, 2009

(30) Foreign Application Priority Data
Jan. 19, 2009 (TW) 98101916

(51) Int. Cl. G06F 13/00; G06F 13/12

(52) U.S. Cl. 710/65; 710/316

(57) ABSTRACT

A keyboard-mouse switch is disclosed. The keyboard-mouse switch mentioned above is embedded in a computer apparatus and includes an information monitoring unit, a hot-key look up table and a hot-key identification controller. The information monitoring unit receives input information generated by at least one of a keyboard and a mouse. The hot-key look up table stores at least start up hot-key information. The hot-key identification controller receives the start up hot-key information and the input information. The hot-key identification identifies whether the input information is hot-key information or not and dis/enables the input information to be transmitted to the computer apparatus according to the start up hot-key information and the hot-key information.

### CROSS-REFERENCE TO RELATED APPLICATION

This application claims the priority benefit of Taiwan application serial no. 98101916, filed Jan. 19, 2009. The entirety of the above-mentioned patent application is hereby incorporated by reference herein and made a part of specification.

### BACKGROUND OF THE INVENTION

1. Field of the Invention

The present invention relates to a keyboard-mouse switch and switching method thereof.

2. Description of Related Art

With the progress of electronic technology and the arrival of information area, the situation of operating multiple computer apparatus simultaneously is more and more popular in modern society. In the conventional art, every individual computer apparatus has its corresponding user input interface such as a single keyboard, a single mouse, or both a keyboard and a mouse for simultaneous input and operations of the computer apparatus. Therefore, a great number of keyboards and mice have to be used to operate multiple computer apparatus.

That is to say, in the conventional art, the number of keyboards and mice placed on the desktop has to be unavoidably the same as the number of computer apparatus so as to operate multiple computer apparatus, and a large area is occupied virtually. In addition, the preparation of a plurality of sets of keyboards and mice also causes the increase of the cost. Besides, when users uses computer apparatus, they need to change their positions continuously, which causes the inconvenience of usage.

Based on the above, in the conventional art, a keyboard video mouse (KVM) switch is also provided for switching a keyboard and a mouse among different computer apparatus. The KVM switch is externally connected among multiple computer apparatus, keyboards, monitors and mice to switch and select the computer apparatus to be corresponding to the keyboards, monitors and mice. However, the KVM switch needs to be additionally purchased and the price is comparatively high. However, hot keys set in the KVM switch can not be set by users at will, and once the hot keys are in conflict with hot keys of application programs in the computer apparatus, the difficulty of usage is caused.

### SUMMARY OF THE INVENTION

The present invention provides a keyboard-mouse switch embedded in a computer apparatus to switch information transmission of a keyboard or a mouse to a computer apparatus by means of hot-key information.

The present invention provides a keyboard-mouse switching method, to switch information transmission of a keyboard or a mouse to a computer apparatus by means of hot-key information.

The present invention provides a keyboard-mouse switch embedded in a computer apparatus. The keyboard-mouse switch includes an information monitoring unit, a hot-key look up table and a hot-key identification controller. The information monitoring unit monitors and receives an input information generated by at lease one of a keyboard and a mouse, and transmits the input information. The hot-key look up table stores at least one start up hot-key information. The hot-key identification controller is coupled to the information monitoring unit and the hot-key look up table to receive the input information and identify whether the input information is hot-key information. The hot-key identification controller further receives the start up hot-key information and dis/enables the input information to be transmitted to the computer apparatus according to the hot-key information and the start up hot-key information.

In an embodiment of the present invention, the said hot-key identification controller includes a hot-key identification unit, an enabling controller and an information identification unit. The information identification unit is coupled to the information monitoring unit to receive and identify whether input information is hot-key information. The hot-key identification unit is coupled to the hot-key look up table, the information identification unit and the enabling controller, to receive the hot-key information and the start up hot-key information and generate a start up flag according to the hot-key information and start up hot-key information. The enabling controller is coupled to the hot-key identification unit and the information identification unit to receive the input information and the start up flag and determines whether to transmit the input information to the computer apparatus according to the start up flag.

In an embodiment of the present invention, when the said hot-key identification unit determines that the hot-key information is equal to the start up hot-key information, the start up flag is enabled. In addition, when the hot-key identification unit determines that the hot-key information is not equal to the start up hot-key information, the start up flag is disabled.

In an embodiment of the present invention, when the said start up flag is enabled, an enabling controller receives the input information from the information identification unit and transmits the input information to the computer apparatus.

In an embodiment of the present invention, the said keyboard-mouse switch further includes a simulation unit. The simulation unit is coupled to the hot-key look up table and the hot-key identification controller so as to provide the virtual key information to the hot-key identification controller according to the start up flag.

In an embodiment of the present invention, the said hot-key look up table further includes the storage of type information of the keyboard and mouse.

In an embodiment of the present invention, the said virtual key information includes the type information.

In an embodiment of the present invention, the said simulation unit provides the virtual key information to the enabling controller when a start up flag is disabled.

In an embodiment of the present invention, the said information identification unit includes a selection circuit. When the input information is the hot-key information, the selection circuit transmits the hot-key information to the hot-key identification unit; when the input information is not the hot-key information, the selection circuit transmits the input information to the enabling controller.

In an embodiment of the present invention, the said keyboard-mouse switch further includes a keyboard controller which is coupled to the hot-key identification controller and is used to transmit the input information to the computer apparatus.

In an embodiment of the present invention, the said hot-key look up table is a memory.

The present invention further provides a keyboard-mouse switching method to switch at least one of a keyboard and a mouse to transmit input information to a computer apparatus, wherein the input information generated by a keyboard or a mouse is first received and is also monitored to determine whether the input information is hot-key information, next, start up hot-key information is read, and then a determination on whether the input information generated by the keyboard or the mouse is transmitted to the computer apparatus is made according to the hot-key information and the start up hot-key information.

Based on the above, the present invention instantly and continuously monitors whether input information transmitted by at least one of a keyboard and a mouse is the same as hot-key information, so as to determine whether the input information transmitted by at least one of the keyboard and the mouse is transmitted to the corresponding computer apparatus. Therefore, a single set of a keyboard or mouse can operate in correspondence to a rather larger number of computer apparatus by means of a single one-to-many transmission line or a single frequency wireless transmission device, and thus hardware cost can be effectively economized.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a keyboard-mouse switch 100 according to an embodiment of the present invention.

FIG. 2 illustrates a flow diagram according to an embodiment of a keyboard-mouse switching method of the present invention.

FIG. 3A illustrates a flow diagram according to another embodiment of a keyboard-mouse switching method of the present invention.

FIG. 3B illustrates a schematic diagram of an embodiment in which a keyboard-mouse switch of the present invention operates in correspondence to a plurality of computer apparatus.

FIG. 3C illustrates a schematic view of another embodiment in which a keyboard-mouse switch of the present invention operates in correspondence to a plurality of computer apparatus.

### DESCRIPTION OF EMBODIMENTS

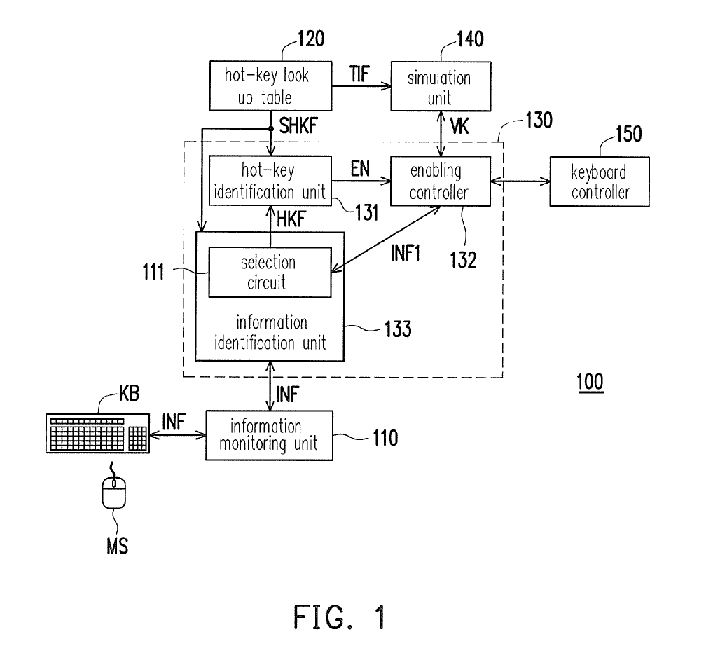

Firstly referring to FIG. 1, FIG. 1 illustrates a keyboard-mouse switch 100 according to an embodiment of the present invention. The keyboard-mouse switch 100 is embedded in a computer apparatus (not illustrated). The keyboard-mouse switch 100 includes an information monitoring unit 110, a hot-key look up table 120, and a hot-key identification controller 130, wherein the hot-key identification controller 130 is coupled to the information monitoring unit 110 and the hot-key look up table 120. The information monitoring unit 110 monitors whether at least one of a keyboard KB and a mouse MS generates input information INF and transmits the input information INF to the hot-key identification controller 130.

Here, in order to avoid losing hot-key information generated by at least one of the keyboard KB and mouse MS, when the computer apparatus is at a turned-on state, the information monitoring unit 110 continuously performs monitoring.

The hot-key identification controller 130 includes a hot-key identification unit 131, an enabling controller 132, and an information identification unit 133, wherein the hot-key identification unit 131 is coupled to the hot-key look up table 120 and the information identification unit 133, and the enabling controller 132 is coupled to the hot-key identification unit 131 and the information identification unit 133.

The information identification unit 133 receives the input information INF and proceeds to identify the input information INF according to start up hot-key information SHKF stored in the hot-key look up table 120, so as to verify whether the input information INF is hot-key information HKF. It should be especially noted that the so-called hot-key information, taking the input information INF generated by the keyboard KB as an example, can be composite keys combining Ctrl, Shift, or ALT on the keyboard KB (e.g. Ctrl+letter “A”) or combining Ctrl, Shift, or ALT and a function key (e.g. Ctrl+ALT+F1); it can also be a combination of other multiple keys or single or multiple presses on a single key, etc. In addition, the hot-key information can also be clicking the left button of the mouse MS for 3 consecutive times, or clicking the right button for 4 consecutive times, or the combination of clicking all buttons on the mouse MS.

When the information identification unit 133 monitors that the input information INF is the hot-key information, the information identification unit 133 transmits the hot-key information HKF to the hot-key identification unit 131. Besides, the hot-key identification unit 131 reads the start up hot-key information SHKF stored in the hot-key look up table 120 and compares the start up hot-key information SHKF and the hot-key information HKF to decide whether to disable or enable the input information INF to be transmitted to the computer apparatus.

In the present embodiment, the information identification unit 133 includes a selection circuit 111, wherein when the information identification unit 133 confirms the input information INF as the hot-key information, the selection circuit 111 transmits the hot-key information HKF to the hot-key identification unit 131 in the hot-key identification controller 130. Additionally, when the input information INF is not the hot-key information, the selection circuit 111 transmits input information INF1 which is not the hot-key information to the enabling controller 132 in the hot-key identification controller 130.

The hot-key identification unit 131 receives the hot-key information HKF transmitted by the information monitoring unit 110 and reads the start up hot-key information SHKF through the hot-key look up table 120. The hot-key identification unit 131 is used to perform a comparison between the start up hot-key information SHKF and hot-key information HKF and to thereby generate a start up flag EN.

The enabling controller 132 determines whether the input information INF1 which is not the hot-key information is transmitted to the computer apparatus according to the dis/enablement of the start up flag EN. Simply speaking, when the start up flag EN is enabled, the enabling controller 132 transmits the input information INF1 which is not the hot-key information to the computer apparatus.

In other words, the start up hot-key information SHKF recorded in the hot-key look up table 120 represents that the computer apparatus to which the keyboard-mouse switch 100 belongs is receiving the hot-key information HKF which is the same as the start up hot-key information SHKF, which means that the user intends to operate the computer apparatus by at least one of the mouse MS and keyboard KB. Under the circumstances, the keyboard-mouse switch 100 starts to transmit the input information INF generated by at least one of the mouse MS and the keyboard KB to the computer apparatus.

It should be noted that, the hot-key look up table 120 can be implemented by a memory. The memory mentioned here can be a volatile memory or a non-volatile memory. In addition, the hot-key look up table 120 can be constructed with equally effective components which can provide memory function, and is not limited to the memory mentioned in the specification. The start up hot-key information SHKF can be stored in the hot-key look up table 120 by means of keyboard scan codes thereof. Accordingly, the hot-key identification unit 131 can determine whether to transmit the input information INF generated by at least one of the mouse MS and the keyboard KB by checking the keyboard scan codes of the start up hot-key information SHKF and the hot-key information HKF.

In addition, the keyboard-mouse switch 100 of the present embodiment further includes a simulation unit 140 and the simulation unit 140 is coupled to the hot-key look up table 120 and the hot-key identification controller 130. The disposition of the simulation unit 140 is for that, when the computer apparatus is turned on and self tests on the keyboard and mouse are performed, the simulation unit 140 can provide virtual key information VK to the hot-key identification controller 130, and transmit the virtual key information VK to the computer apparatus through the hot-key identification controller 130 in order to pass the self testing of the computer apparatus. In addition, when the input terminal of the keyboard and the mouse of the computer apparatus is at a tri-state, and the computer apparatus needs to use (and check) the input generated by at least one of the keyboard and the mouse, the simulation unit 140 can correspondingly generate the virtual key information VK to the computer apparatus. In other words, when the start up flag is disabled, the simulation unit 140 provides the virtual key information VK to the enabling controller 132 so as to simulate the condition that at least one of the keyboard and the mouse is connected to the computer apparatus.

Since the said computer apparatus, during the power-on self test, checks the types of the keyboard and mouse (e.g. IBM PC/XT, IBM PC/AT, or IBM PS/2 or other types of keyboard, etc), the virtual key information VK provided by the simulation unit 140 includes type information TIF about the types of keyboard and mouse. In addition, the type information TIF is stored in the hot-key look up table 120 for the simulation unit 140 to read and accordingly generate the virtual key information VK.

Additionally, the keyboard-mouse switch 100 further includes a keyboard controller 150. The keyboard controller 150 is coupled to the hot-key identification controller 130 and used to transmit the input information INF transmitted from the hot-key identification controller 130 to the computer apparatus.

Please especially note that the keyboard-mouse switch 100 of the present embodiment is embedded in a computer system. For example, the keyboard-mouse 100 can be configured in a Super Input Output (SIO) unit in the computer apparatus. Therefore, if the users use a computer apparatus equipped with the keyboard-mouse switch 100, they need not purchase additional equipments and can actually operate multiple computer apparatus by a set of a keyboard KB and a mouse MS or one of them. Besides, since the keyboard-mouse switch 100 is configured in the SIO unit in the computer apparatus, no matter it is a keyboard KB and mouse MS with a wired interface or a keyboard KB and mouse MS with a wireless interface, the users can use the keyboard-mouse switch 100 to switch to the computer apparatus to be operated.

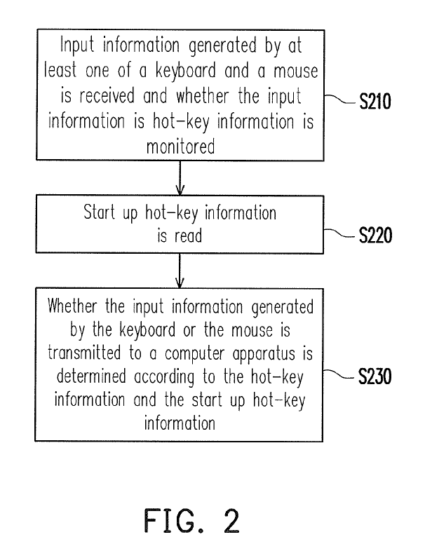

Referring to FIG. 2, FIG. 2 illustrates a flow diagram according to an embodiment of a keyboard-mouse switching method of the present invention. The method includes: firstly, in step S210, input information generated by at least one of a keyboard and a mouse is received and, in step S220, whether the input information is hot-key information is monitored. Next, in step S230, start up hot-key information is read and whether the input information generated by the keyboard or the mouse is transmitted to a computer apparatus is determined according to the hot-key information and the start up hot-key information. Simply speaking, the present embodiment, by monitoring and determining whether the input information generated by the keyboard or the mouse is the same as the start up hot-key information pre-stored in a memory, when the input information equal to the start up hot-key information, at least one operating interface of a computer apparatus of the keyboard and the mouse is activated. On the contrary, when the input information is not equal to the start up hot-key information, at least one operating interface of the computer apparatus of the keyboard and the mouse is shut off.

In order to make persons of ordinary skilled in the art understand the present invention better, another embodiment according to the switching method of keyboard and mouse of the present invention is provided below.

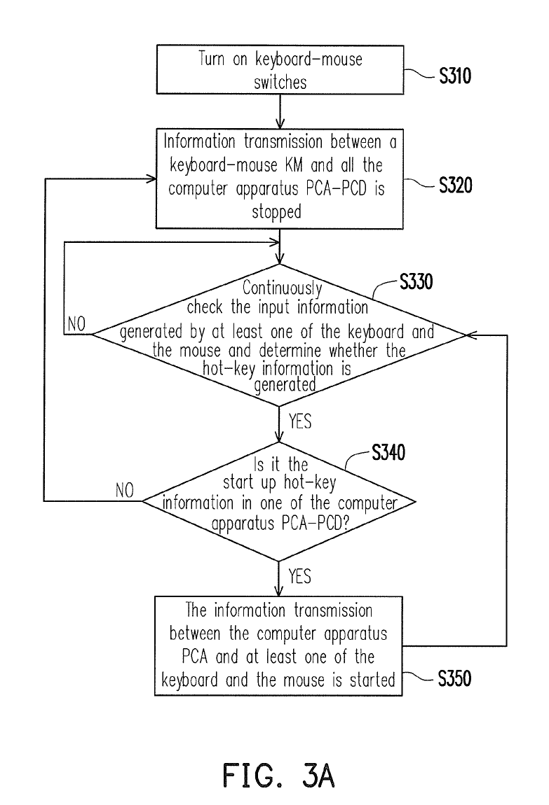

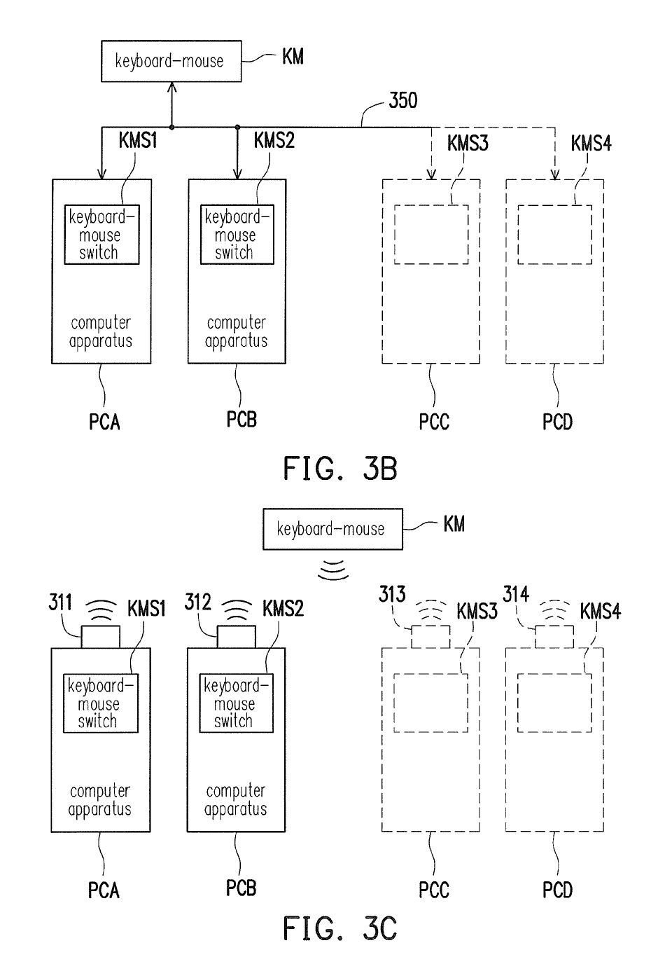

Refer to FIGS. 3A and 3B at the same time, wherein FIG. 3A illustrates a flow diagram according to another embodiment of a keyboard-mouse switching method of the present invention. FIG. 3B illustrates a schematic view of an embodiment operating a plurality of computer apparatus by a keyboard-mouse switch of the present invention. Firstly, in step S310, keyboard-mouse switches KMS1-KMS4 of all computer apparatus PCA-PCD are sequentially turned on. In step S320, information transmission between a keyboard-mouse KM and all the computer apparatus PCA-PCD is stopped, and the input terminals of keyboard-mouse KM of computer apparatus PCA-PCD are in a tri-state.

In step S320, since keyboard-mouse switches KMS1-KMS4 are on, the keyboard-mouse switches KMS1-KMS4 will simultaneously and continuously receive the input information generated by the keyboard-mouse KM and check the existence of hot-key information in the input information. If the input information generated by the keyboard-mouse KM does not include the hot-key information, the keyboard-mouse switches KMS1-KMS4 remain in the status as in step S330. On the contrary, in step S340, if keyboard-mouse switches KMS1-KMS4 verify that the input information generated by the keyboard-mouse KM includes the hot-key information, the keyboard-mouse switches KMS1-KMS4 respectively compare the hot-key information with the respectively stored start up hot-key information thereof and thereby determine that the keyboard-mouse KM is to start up operation in correspondence to one of the computer apparatus PCA-PCD. In step S350, for instance, if the hot-key information transmitted by the keyboard-mouse KM is the same as the start up hot-key information stored in the keyboard-mouse switch KMS1 of the computer apparatus PCA, then the information transmission between the computer apparatus PCA and the keyboard-mouse KM is started.

If the hot-key information is determined as not the same as the start up hot-key information stored in any of the keyboard-mouse switches KMS1-KMS4 in step S340, execution reverts to S320 and detection on new hot-key information is performed again.

In addition, after starting up the information transmission between the computer apparatus PCA and the keyboard-mouse KM, the keyboard-mouse switches KMS1-KMS4 continuously check whether hot-key information exists in the input information to wait for switching the operations of the keyboard-mouse KM in correspondence to the other computer apparatus PCB, PCC or PCD.

Additionally speaking, merely a single to one-to-many channel transmission line 350 is needed to connect the keyboard-mouse KM and the computer apparatus PCA-PCD to complete information transmission. The transmission line 350 can use, for example, a PS/2 format transmission wire. Of course, the information transmission between the keyboard-mouse KM and the computer apparatus PCA-PCD can also be performed by wireless transmission.

Of course, in the embodiment of the present invention, the transmission between the keyboard-mouse KM and the computer apparatus PCA-PCD can also be performed by wireless transmission. Referring to FIG. 3C, FIG. 3C illustrates a schematic view of another embodiment in which a plurality of computer apparatus by a keyboard-mouse switch of the present invention, wherein the computer apparatus PCA-PCD have their own wireless modules 311-314.

In addition, the keyboard-mouse KM builds up transmission relations with one of the computer apparatus PCA-PCD via the wireless modules 311-314 and operates in correspondence to one of the computer apparatus PCA-PCD.

In summary, the present invention uses a keyboard-mouse switch embedded in a computer apparatus to detect hot-key information generated by at least one of a keyboard and a mouse and compares the hot-key information with start up hot-key information pre-stored in the keyboard-mouse switch so as to switch operations of the keyboard mouse in correspondence to a computer apparatus. No additional hardware equipment is required, spaces are not occupied, and the cost is lowered. Besides, the keyboard-mouse switch can also be configured in an SIO unit so as to be used in a wired or wireless manner.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A keyboard-mouse switch, embedded in a computer apparatus, the keyboard-mouse switch comprising:
an information monitoring unit, monitoring and receiving input information generated by at lease one of a keyboard and a mouse, and transmitting the input information;
a hot-key look up table, storing at least one start up hot-key information; and
a hot-key identification controller, coupled to the information monitoring unit and the hot-key look up table, receiving the input information and identifying whether the input information is hot-key information, further receiving the hot-key information, and disabling or enabling the input information to be transmitted to the computer apparatus according to the hot-key information and the start up hot-key information.

2. The keyboard-mouse switch according to claim 1, wherein the hot-key identification controller comprises:
an information identification unit, coupled to the information monitoring unit to receive and identify whether the input information is the hot-key information;
a hot-key identification unit, coupled to the hot-key look up table and the information identification unit to receive the hot-key information and the start up hot-key information and generate a start up flag according to the hot-key information and start up hot-key information; and
an enabling controller, coupled to the hot-key identification unit and the information identification unit to receive the input information and the start up flag, and determines whether to transmit the input information to the computer apparatus according to the start up flag.

3. The keyboard switch according to claim 2, wherein when the hot-key identification unit determines that the hot-key information is the same as the start up hot-key information, the start up flag is enabled; when the hot-key identification unit determines that the hot-key information is not the same as the start up hot-key information, the start up flag is disabled.

4. The keyboard switch according to claim 3, wherein when the start up flag is enabled, the enabling controller receives the input information from the information identification unit and transmits the input information to the computer apparatus.

5. The keyboard-mouse switch according to claim 2, further comprising:
a simulation unit, coupled to the hot-key look up table and the hot-key identification controller, for providing virtual key information to the hot-key identification controller according to the start up flag.

6. The keyboard-mouse switch according to claim 5, wherein the hot-key look up table further comprises a type information, wherein the type information is a type of the mouse and the keyboard.

7. The keyboard-mouse switch according to claim 6, wherein the virtual key information comprises the type information.

8. The keyboard-mouse switch according to claim 5, wherein the simulation unit provides the virtual key information to the enabling controller when the start up flag is disabled.

9. The keyboard-mouse switch according to claim 1, wherein the information identification unit comprises:
a selection circuit, wherein when the input information is the hot-key information, the selection circuit transmits the hot-key information to the hot-key identification unit, and when the input information is not the hot-key information, the selection circuit transmits the input information to the enabling controller.

10. The keyboard-mouse switch according to claim 1, further comprising:
a keyboard controller coupled to the hot-key identification controller to transmit the input information to the computer apparatus.

11. The keyboard-mouse switch according to claim 1, wherein the hot-key look up table is a memory.

12. A keyboard-mouse switching method, for switching a keyboard, a mouse, and at least one of the keyboard and the mouse to transmit input information to a computer apparatus, the method comprising:
receiving the input information generated by at least one of the keyboard and the mouse, and monitoring whether the input information is hot-key information;
reading start up hot-key information; and
determining whether the input information generated by the keyboard or the mouse is transmitted to the computer apparatus according the hot-key information and the start up hot-key information.

13. The keyboard-mouse switching method according to claim 12, wherein the start up hot-key information is stored in a memory.

14. The keyboard-mouse switching method according to claim 13, wherein the memory further comprises type information storing a type of the mouse and the keyboard.

15. The keyboard-mouse switching method according to claim 14, further comprising:
providing a virtual key information to an enabling controller according to an enable flag, wherein the virtual key is generated according to the start up hot-key information and the hot-key information.

16. The keyboard-mouse switching method according to claim 15, wherein the virtual key information comprises the type information.

17. The keyboard-mouse switching method according to claim 12, wherein the step of “determining whether the input information generated by the keyboard or the mouse is transmitted to the computer apparatus according the hot-key information and the start up hot-key information” comprises:
enabling a start up flag when the hot-key information is the same as the start up hot-key information; and
disabling the start up flag when the hot-key information is not the same as the start up hot-key information.

18. The keyboard-mouse switching method according to claim 17, wherein the step of “determining whether the input information generated by the keyboard or the mouse is transmitted to the computer apparatus according the hot-key information and the start up hot-key information” further comprises:
transmitting the input information generated by one of the keyboard and the mouse to the computer apparatus when the start up flag is enabled.
